(19) United States
(12) Patent Application Publication
(10) Pub. No.: US 2018/0351444 A1
(43) Pub. Date: Dec. 6, 2018

(54) SUSPENDED MAGNET IMPACT ENERGY HARVESTER

(71) Applicant: Uncharted Power, Inc., New York, NY (US)

(72) Inventors: Jessica O. Matthews, New York, NY (US); Daniel Bish, Brooklyn, NY (US)

(21) Appl. No.: 15/980,412

(22) Filed: May 15, 2018

Related U.S. Application Data
(60) Provisional application No. 62/513,366, filed on May 31, 2017.

(51) Int. Cl. H02K 35/06; H02K 5/04; H02K 7/00

(52) U.S. Cl. CPC H02K 35/06; H02K 7/003; H02K 5/04

(57) ABSTRACT

Provided are systems, methods, and devices for harvesting kinetic energy and generating electrical power. An energy harvesting system may comprise a plurality of multi-directional suspended magnets to harvest kinetic energy from multi-directional impacts, accelerations, and rotations experienced by an object. The energy harvesting system may be implemented as a recreational device or a utility device.

### CROSS-REFERENCE

This application claims the benefit of U.S. Provisional Patent Application No. 62/513,366, filed May 31, 2017, which application is entirely incorporated herein by reference.

### BACKGROUND

An estimated 1.2 billion people, approximately 16% of the global population, do not have access to electricity, and many more only have access to poor quality electric power. See World Energy Outlook (WEO) Electricity Access Database (2016). This global energy poverty can have detrimental consequences to the population as well as to the environment. For example, households without reliable access to electricity can often depend on pollutant kerosene lamps to provide light after sunset, harming both the respiratory health of the people and the atmosphere exposed to the noxious fumes and pollutants released by the kerosene lamps. Furthermore, alternatives to electricity, such as kerosene, can be very expensive to low-income households.

### SUMMARY

The lack of readily available electricity is a significant problem for a large number of the global population. It can adversely affect the standard of living, work productivity, and technological development within such population. Thus, recognized herein is a need for systems and methods for harvesting energy.

The systems and methods provided herein may harvest energy in environments or areas lacking, or with minimal or limited, access to electricity. Using such systems and methods, energy may be harvested by populations lacking, or with minimal or limited, access to electricity. Unsophisticated users, such as minor children, may be capable of harvesting energy and/or generating electric power implementing the systems and methods described herein. The systems and methods may capture and harvest energy exerted or released, by human and/or machine, in daily life that is otherwise dissipated. The systems and methods may harness movements, impacts, and rotations of a device. The energy harvested may be used to generate electrical power. The energy harvested may be stored, such as in a battery, for long term use and/or future use.

A device implementing the systems and methods described herein can be portable. The device can be light-weight. In some instances, the systems, methods, and devices described herein may be implemented during or as part of recreation. For example, the device can be a recreational device, such as a ball. In some instances, the device can be a utility device, such as a backpack, a floor panel, seat cushion, a hammer, and/or other tool. The device can be any object that experiences sudden brief movements, impacts, vibrations, and/or rotations. The systems and methods for harvesting energy may involve configuring one or more suspended magnets to receive or experience impact or other non-inertial movements.

In an aspect, provided is an energy harvesting device, comprising: a shell defining a cavity; a first magnet disposed in the cavity, wherein the first magnet is suspended by a first set of springs that is fixed relative to the shell, and wherein the first magnet is configured to oscillate in a first linear direction; a second magnet disposed in the cavity, wherein the second magnet is suspended by a second set of springs that is fixed relative to the shell, and wherein the second magnet is configured to oscillate in a second linear direction different from the first linear direction; and a set of conductive coils wrapped around a shaft disposed in the cavity, wherein the shaft is fixed relative to the shell, and wherein the set of conductive coils is adjacent to at least one of the first magnet and the second magnet.

In some embodiments, the set of conductive coils is adjacent to both the first magnet and the second magnet. In some embodiments, longitudinal axes of coils in the set of conductive coils are present in at most two planes. In some embodiments, the first magnet and the second magnet are adjacent and not in contact.

In some embodiments, the shell is substantially spherical.

In some embodiments, the device further comprises a storage device in electrical connection with the set of conductive coils, wherein the storage device is disposed within the cavity.

In some embodiments, the first magnet or the second magnet is a permanent magnet.

In some embodiments, the set of conductive coils is adjacent to the first magnet, and wherein a first longitudinal axis of a given spring in the first set of springs is substantially perpendicular to a second longitudinal axis of a given coil in the set of conductive coils.

In some embodiments, the set of conductive coils is adjacent to the first magnet, and wherein a first longitudinal axis of a given spring in the first set of springs is substantially parallel to a second longitudinal axis of a given coil of the set of conductive coils. In some embodiments, the given spring is disposed within a tube defined by the given coil.

In another aspect, provided is a method for harvesting energy, comprising: (a) providing a device comprising: a shell defining a cavity; a first magnet disposed in the cavity, wherein the first magnet is suspended by a first set of springs that is fixed relative to the shell, and wherein the first magnet is configured to oscillate in a first linear direction; a second magnet disposed in the cavity, wherein the second magnet is suspended by a second set of springs that is fixed relative to the shell, and wherein the second magnet is configured to oscillate in a second linear direction different from the first linear direction; and a set of conductive coils wrapped around a shaft disposed in the cavity, wherein the shaft is fixed relative to the shell, and wherein the conductive coils is adjacent to at last one of the first magnet and the second magnet; and (b) subjecting the device to a brief movement, impact, vibration, or rotation.

In some embodiments, the set of conductive coils is adjacent to both the first magnet and the second magnet. In some embodiments, longitudinal axes of coils in the set of conductive coils are present in at most two planes. In some embodiments, the first magnet and the second magnet are adjacent and not in contact.

In some embodiments, the shell is substantially spherical.

In some embodiments, the method further comprises storing electrical energy harvested by the set of conductive coils to a storage device in electrical connection with the set of conductive coils.

In some embodiments, the first magnet or the second magnet is a permanent magnet.

In some embodiments, the set of conductive coils is adjacent to the first magnet, and wherein a first longitudinal axis of a given spring in the first set of springs is substantially perpendicular to a second longitudinal axis of a given coil in the set of conductive coils.

In some embodiments, the set of conductive coils is adjacent to the first magnet, and wherein a first longitudinal axis of a given spring in the first set of springs is substantially parallel to a second longitudinal axis of a given coil of the set of conductive coils. In some embodiments, the given spring is disposed within a tube defined by the given coil.

A magnet of the present disclosure can be a permanent magnet or a non-permanent magnet (e.g., a temporary magnet) or an electromagnet. The types of permanent magnets may include, but are not limited to, neodymium iron boron, samarium cobalt, alnico, ceramic or ferrite magnets, or any combination thereof. In some instances, other components or devices capable of producing a magnetic flux can be used. For example, electromagnets (e.g., solenoid) may be used, wherein the strength of the magnetic field may be configurable.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein) of which:

FIG. 1A shows an exploded view of an embodiment of an energy harvesting system.

FIG. 1B shows a perspective view of a partial assembly of the energy harvesting system of FIG. 1A.

FIG. 2 shows a perspective view of another embodiment of an energy harvesting system.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Energy harvesting systems and methods are provided. The energy harvesting systems and methods may be implemented as an energy harvesting device. The systems and methods provided herein may harvest energy in environments or areas lacking, or with minimal or limited, access to electricity. Using such systems and methods, energy may be harvested by populations lacking, or with minimal or limited, access to electricity. Unsophisticated users, such as minor children, may be capable of harvesting energy and/or generating electric power implementing the systems and methods described herein.

The systems and methods may capture and harvest energy exerted or released, by human and/or machine, in daily life that is otherwise dissipated. The systems and methods may harness movements, impacts, and rotations of an object. The energy harvested may be used to generate electrical power from such harvested energy. The energy harvested and/or power generated may be stored, such as in a battery or other storage device, for long term use and/or future use.

A device implementing the systems and methods described herein can be an object experiencing movements, impacts, vibrations, and/or rotations. The device can be portable. The device can be light-weight. In some instances, the systems, methods, and devices described herein may be implemented during or as part of recreation. For example, the device can be a recreational device, such as a baseball, lacrosse ball, cricket ball, soccer ball, basketball, tennis ball, or other sports/play product. In some instances, the systems, methods, and devices herein may be implemented during or as part of everyday utility life. For example, the device can be a utility device, such as a backpack, a floor panel, seat cushion, a hammer, and/or other tool. Alternatively or in addition, the device can be any object that experiences sudden brief movements, impacts, and/or rotations. The systems and methods for harvesting energy may involve configuring one or more suspended magnets to receive or experience impact or other non-inertial movements.

Using such device, beneficially, an unsophisticated user may harvest energy in environments or amongst populations lacking, or with minimal or restricted, access to electricity, thus improving the standard of living, work productivity, and technological development within such environments and populations. The device may also be capable of capturing energy (e.g., kinetic energy) that is otherwise dissipated during everyday use.

Reference is now made to the Figures. It will be appreciated that the Figures are not necessarily drawn to scale. While the Figures illustrate certain embodiments, the systems, methods, and devices provided herein are not limited to such embodiments.

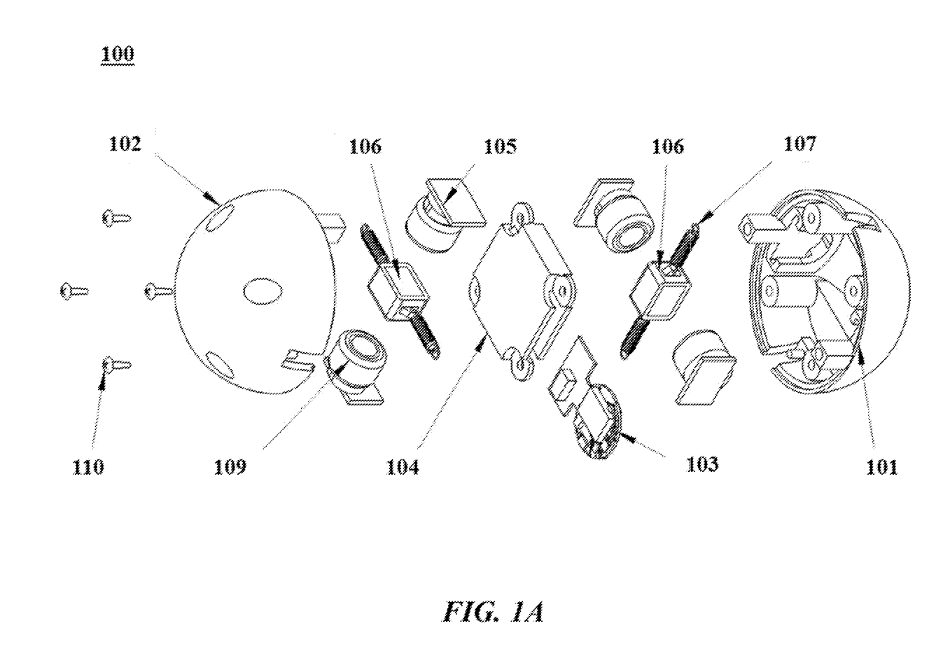

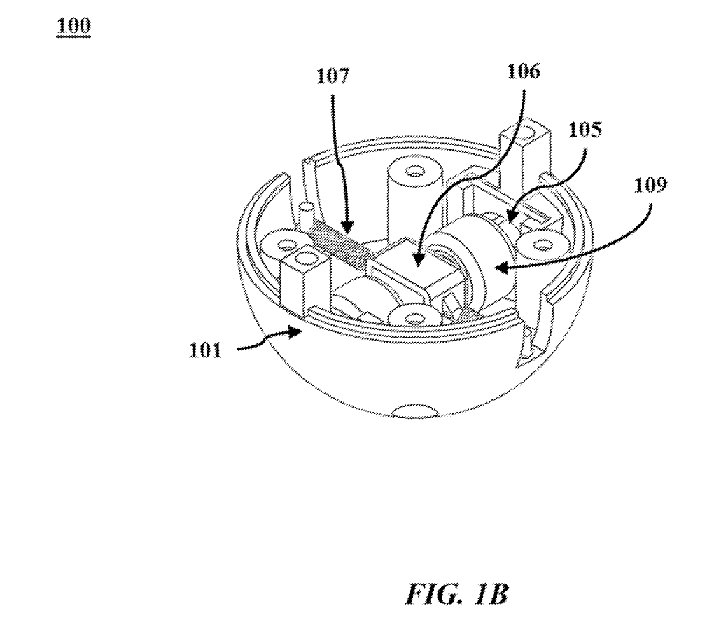

FIG. 1A shows an exploded view of an embodiment of an energy harvesting system. A device 100 has a substantially spherical shape. Alternatively, the device 100, although having a substantially spherical shape as illustrated in FIG. 1A, can have any other arbitrary shape (e.g., spheroid, cubical, pyramid, etc.) that can comprise any combination of flat, angled, and/or round surfaces. The device 100 can comprise a first shell 101 and a second shell 102 that are fastened together to define the substantially spherical shape. Each of the first shell 101 and the second shell 102 can be hemispherical (or polygonal, etc.). Alternatively, the device 100 can comprise any number of shells (e.g., 3, 4, 5, 6, 7, 8, 9, etc.) that can be fastened together to define the shape of the device 100, whether the device be substantially spherical or another arbitrary shape. When the shells 101, 102 are fastened together, a cavity can be defined within. The cavity may be the same shape or form as the device 100. Alternatively, the cavity may be of a different shape or from than the device 100 (e.g., a spherical device has a cuboid form cavity). The cavity can house within the device 100 one or more components, including an encasement 106 housing permanent magnets, a spring suspension system 107, coils 109, a shaft 105, and a printed circuit board 103.

The device 100 may have the dimensions of any recreational or sports device, such as a baseball, basketball, football, rugby ball, soccer ball, bowling ball, volleyball, tennis ball, and the like. For example, the device 100 may have a maximum dimension (e.g., diameter, diagonal, height, width, depth, etc.) of between about 5.0 centimeters (cm) to about 30.0 cm. The device 100 can be a utility device, such as a backpack, a floor panel, a seat cushion, a hammer, and/or other tool. The device can be a type of mobile or personal device, such as a wearable device, fitness tracker, mobile phone, mobile phone case, fashion accessory, and the like. Alternatively or in addition, the device 100 may be at least about 4 cm, 5 cm, 6 cm, 7 cm, 8 cm, 9 cm, 10 cm, 11 cm, 12 cm, 13 cm, 14 cm, 15 cm, 16 cm, 17 cm, 18 cm, 19 cm, 20 cm, 25 cm, 30 cm, 35 cm, 40 cm, 45 cm, 50 cm or more. Alternatively or in addition, the device 100 may be at most about 50 cm, 45 cm, 40 cm, 35 cm, 30 cm, 25 cm, 20 cm, 19 cm, 18 cm, 17 cm, 16 cm, 15 cm, 14 cm, 13 cm, 12 cm, 11 cm, 10 cm, 9 cm, 8 cm, 7 cm, 6 cm, 5 cm, 4 cm, or less. In some instances, a shell of the device 100 may have a maximum thickness of at least about 0.1 cm, 0.2 cm, 0.3 cm, 0.4 cm, 0.5 cm, 0.6 cm, 0.7 cm, 0.8 cm, 0.9 cm, 1.0 cm, 1.1 cm, 1.2 cm, 1.3 cm, 1.4 cm, 1.5 cm, 1.6 cm, 1.7 cm, 1.8 cm, 1.9 cm, 2.0 cm, 2.5 cm, 3.0 cm, 3.5 cm, 4.0 cm, 4.5 cm, 5.0 cm, 6.0 cm, 7.0 cm or more. Alternatively or in addition, a shell of the device 100 may have a maximum thickness of at most about 7.0 cm, 6.0 cm, 5.0 cm, 4.5 cm, 4.0 cm, 3.5 cm, 3.0 cm, 2.5 cm, 2.0 cm, 1.9 cm, 1.8 cm, 1.7 cm, 1.6 cm, 1.5 cm, 1.4 cm, 1.3 cm, 1.2 cm, 1.1 cm, 1.0 cm, 0.9 cm, 0.8 cm, 0.7 cm, 0.6 cm, 0.5 cm, 0.4 cm, 0.3 cm, 0.2 cm, 0.1 cm or less. Any component housed in the cavity defined by the shells of the device 100, such as the encasement 106 housing the permanent magnets, spring suspension system 107, coils 109, shaft 105, and printed circuit board 103, may each have dimensions sufficient to fit within the cavity of the device. In some embodiments, the device can be thin (e.g., having small thickness) with a relatively small (e.g., thin) cavity defined therein, such as to create an almost flat embodiment, such as a flat spheroid or a flat cuboid.

The shells 101 and 102 can be fastened together such as via complementary fastening structures. For example, the first shell 101 and the second shell 102 can complete a form-fitting pair. In some instances, the first shell 101 can comprise a form-fitting male component and the second shell 102 can comprise a complementary form-fitting female component, and/or vice versa. In some instances, an outer diameter of a protrusion-type fastening structure of the first shell 101 can be substantially equal to an inner diameter of a depression-type fastening structure of the second shell 102, such that the protrusion-type fastening structure can be inserted into the depression-type structure in a form-fitting manner. Alternatively or in addition, an outer diameter of a protrusion-type fastening structure of the second shell 102 can be substantially equal to an inner diameter of a depression-type fastening structure of the first shell 101, such that the protrusion-type fastening structure of the second shell 102 can be inserted into the depression-type fastening structure of the first shell 101 in a form-fitting manner. Alternatively or in addition, the two shells 101, 102 can comprise other types of complementary structures (e.g., hook and loop, latches, snap-ons, buttons, nuts and bolts, internal and external threads, complementary grooves, etc.) that can be fastened together. For example, the two shells 101, 102 can be fastened together via one or more screws 110. Alternatively or in addition, the two shells 101, 102 can be fastened using other fastening mechanisms, such as but not limited to staples, clips, clamps, prongs, rings, brads, rubber bands, rivets, grommets, pins, ties, snaps, velcro, adhesives (e.g., glue), tapes, a combination thereof, or any other types of fastening mechanisms.

The fastening can be temporary, such as to allow for subsequent unfastening of the two shells 101, 102 without damage (e.g., permanent deformation, disfigurement, etc.) to the two shells 101, 102 or with minimal damage. The fastening can be permanent, such as to allow for subsequent unfastening of the two shells 101, 102 only by damaging at least one of the two shells. One of the two shells 101, 102, or both, can be temporarily or permanently deformed (e.g., stretched, compressed, etc.) and/or disfigured (e.g., bent, wrinkled, folded, creased, etc.) or otherwise manipulated when fastened to each other or during fastening. In some instances, one or both of the two shells 101, 102 can be cut into or pierced by the other when the two shells 101, 102 are fastened together.

The cavity in the device 100, defined by the two shells 101, 102, can an encasement 106 housing one or more permanent magnets. In some instances, each permanent magnet can reside in an independent encasement 106. In some instances, a plurality of permanent magnets can reside in a single encasement 106. In some instances, every permanent magnet in the cavity in the device 100 can reside in a single encasement 106. Each permanent magnet and/or each encasement 106 can be suspended from a spring suspension system 107. Alternatively or in addition, non-permanent magnets can be used, so long as they are capable of producing a magnetic flux, for example over adjacent coils 109. Alternatively or in addition, other components or devices capable of producing a magnetic flux can be used. For example, electromagnets (e.g., solenoid) may be used, wherein the strength of the magnetic field may be configurable.

Via the spring suspension system 107, a given permanent magnet (e.g., encased in the encasement 106) can have an equilibrium position (or resting state) and non-equilibrium positions. A permanent magnet may be capable of oscillating between the equilibrium position and non-equilibrium positions, such as upon receiving impact and/or undergoing accelerations, decelerations, and/or rotations. In some instances, the equilibrium position may be at substantially the center of the device 100. In some instances, the equilibrium position may be at a different location in the cavity of the device 100.

The spring suspension system 107 can comprise any number of springs to suspend a given encasement 106 comprising the one or more permanent magnets, such as 1, 2, 3, 4, 5, 6, 7, 8, 9, or more springs. For example, as shown in FIG. 1A, a given permanent magnet (or encasement 106) can be suspended by two springs on opposing sides of the given permanent magnet (or encasement 106). One or more springs can be coupled to the encasement 106 in any configuration (e.g., on opposing sides, on each side of the housing, symmetrically, asymmetrically, etc.). Alternatively or in addition, the spring suspension system 107 can comprise other spring-like components to suspend the one or more permanent magnets in the encasement 106. For example, the spring-like component can be an elastomeric component (e.g., rubber, etc.) or a plastic having flexibility and/or semi-rigidity. Each spring or spring-like component can comprise two ends, a first end fastened to a permanent magnet (or encasement 106), and a second end fastened to one or more shells 101, 102 of the device 100. The springs and/or spring-like components can be configured to, individually or collectively, oscillate the permanent magnet (or encasement 106) they are suspending between an equilibrium position and non-equilibrium positions.

The device 100 can comprise one or more sets of conductive coils 109. The conductive coils 109 can comprise, for example, copper wire. The conductive coils 109 can be wrapped around a shaft 105. The shaft 105 can comprise high permeability material, such as iron or silicon steel. The shaft 105 can be cylindrical such that the conductive coils 109 are wrapped around in a helical path around the shaft. Alternatively, the shaft can be any arbitrary shape 105. The shaft 105 with the conductive coils 109 wrapped around can be fastened to one or more shells 101, 102 of the device 100, for example, via one or more fastening methods described elsewhere herein. For example, the shaft 105 can comprise a base structure that is insertable into a depression-type structure in one of the two shells 101, 102. The shaft 105 can be disposed in the cavity of the device 100 in a location that allows a movement (e.g., oscillation) of the permanent magnets to produce a magnetic flux over the conductive coils 109. Alternatively, the set of conductive coils 109 can stand alone without a shaft. For example, the conductive coils 109 may be wrapped in a tubular shape on their own and directly coupled to the cavity (e.g., the first shell or second shell). In some instances, as shown in FIG. 1A, the suspended permanent magnet can be adjacent or otherwise disposed proximally to the conductive coils 109. In some instances, the suspended permanent magnet can be located at or near a central axis of the circular conductive coils 109.

In operation, the device 100 can experience a movement due to an impact, acceleration, deceleration, rotation, vibration, and/or other non-inertial movement. This movement can cause the permanent magnet to oscillate via the spring suspension system 107. For example, once a permanent magnet suspended by each of a first spring and a second spring on opposite sides of the permanent magnet has been displaced from its equilibrium position due to an impact, at least one of the two springs can be overextended. By way of example, if the first spring has been overextended, it can thereafter retract, thus overextending the second spring that is coupled to the other side of the permanent magnet. The two springs can continue to overextend and retract in oscillation until the potential energy stored in the spring suspension system 107 from the impact has been expended. The oscillating permanent magnet which is adjacent to the conductive coils 109 can produce a changing magnetic flux over the conductive coils 109, thereby driving a current (or inducing a voltage) through the coils due to electromagnetic induction. The conductive coils 109 can be electrically coupled to an electrical system (e.g., printed circuit board, battery, electrical load, socket, other electrical circuit or electrical components, etc.) to store or use the electrical power generated. Thus, the device harvests kinetic energy of the device 100 to convert to potential energy in the spring suspension system 107, which is in turn converted to electrical energy via electromagnetic induction.

The device 100 may further comprise within its cavity, a printed circuit board 103 which is electrically coupled to the conductive coils 109 to harness the electrical power that is produced by the device. The printed circuit board 103 can be nested inside a protective housing 104. The protective housing 104 may provide other structural benefits to the device 100, such as by providing a fastening medium for the two shells 101, 102, and/or fastening of one or more other components.

The device 100 may comprise a plurality of permanent magnets. The permanent magnet may be supported by an encasement 106. For example, the permanent magnet may be, entirely or partially, encased within the encasement 106 and/or placed externally on the encasement 106, such as on one or more external surfaces of the encasement 106. The encasement 106 may have any form or shape. For example, the encasement may be rectangular, spherical, polygonal, or be another arbitrary shape. The encasement may have any number of faces. Each of the permanent magnets can be suspended in a plurality of directions via a plurality of spring suspension systems 107. For example, FIG. 1A shows two encasements 106 housing the permanent magnets, each suspended in a different direction. The device 100 may comprise 1, 2, 3, 4, 5, 6, 7, 8, 9, 10, 11, 12, 13, 14, 15, 20, 25, 30, or more permanent magnets. The plurality of permanent magnets may be suspended in different directions, wherein the different directions can range in three dimensions. Some of the plurality of permanent magnets may be suspended in the same direction. Beneficially, this multi-directional suspension may allow the device 100 to harness energy efficiently from stochastic, non-uniform movements. For example, the device 100 may experience an impact, acceleration, deceleration, vibration, rotation, and/or other non-inertial force coming from or going towards any direction. For instance, a permanent magnet suspended in a first linear direction by two springs in a spring suspension system may not be able to harvest kinetic energy, at least efficiently, which comes from an impact in a direction normal to the first linear direction. By having multi-directional suspension, another magnet suspended in a non-normal direction to the motion may harvest such energy.

In some instances, the device 100 may comprise one or more sensors, such as a smart chip. The sensors may be electrically coupled to the coils 109 and/or the printed circuit board 103, such that the device 100 can electrically power the one or more sensors. In an example, the smart chip may be capable of tracking a speed, acceleration, deceleration, spin and/or various other aspects related to the motion or the operation of the device 100 (or housing thereof). In some instances, a location sensor may be capable of tracking a location of the device 100, such as via communicating with a global positioning system (GPS) or a system implementing a triangulation method.

In some instances, the device 100 may comprise a storage device, such as a battery. The battery may be electrically coupled to the coils 109 and/or the printed circuit board 103, such that the device 100 can store electric power generated by the device 100 into the battery. The battery may be coupled to other electrical systems, such as an electrical load, socket, and/or one or more smart chips that may be internal to or external to the device 100. In some instances, the battery may be removed from within the cavity. In some instances, the battery may be accessed from within the cavity via one or more sockets which are exposed to an outer region of the device 100 (relative to the shells 101, 102). The battery may be rechargeable. For example, the battery may be a lithium ion battery. The device 100 may store energy in other electrical energy storage devices, such as capacitors, supercapacitors, fuel cells, other electrochemical cells, and the like.

FIG. 1B shows a perspective view of a partial assembly of the energy harvesting system of FIG. 1A. The device 100 can be assembled such that first shell 101 houses an encasement 106 housing the permanent magnet, and two coils 109 each adjacent to opposite sides of the encasement. The two coils may each be wrapped around a separate shaft 105 fixed to the first shell. The encasement may be suspended between the two coils via the spring suspension system 107. As shown in FIG. 1B, where the encasement 106 defines a substantially cuboid shape, and has six faces including a top face, bottom face, and four side faces. Each of the four side faces of the encasement 106 may be adjacent to one of a spring (e.g., 107) and a coil (e.g., 109) in alternating fashion. That is, a longitudinal axis of a coil and a longitudinal axis of a spring may be substantially normal with respect to each other. A longitudinal axis of a first coil and a longitudinal axis of a second coil in the first shell 101 may be substantially parallel and/or coincident. A longitudinal axis of a first spring and a longitudinal axis of a second spring in the first shell 101 may be substantially parallel and/or coincident. In other embodiments, the springs and coils in the first shell 101 may be arranged in any arrangement. For example, a spring may be disposed within a tube (e.g., cylindrical shape or other tube) defined by a coil such that the spring and the coil have substantially parallel and/or coincident longitudinal axes.

The permanent magnet in the encasement 106 may be oriented in any direction with respect to the coils and/or the springs. For example, a north-south axis of the permanent magnet may be normal or substantially normal to a longitudinal axis of the coil. In another example, a north-south axis of the permanent magnet may be parallel or substantially parallel to a longitudinal axis of the coil.

In other embodiments, the locations of the coils (e.g., 109) and the magnets (e.g., encased in encasement 106) may be reversed such that the magnets are fixed relative to the first shell 101 and the coils are suspended via the spring suspension system (e.g., 107) such that the coils are adjacent and move relative to the magnets. The device 100 may have any other arrangement or configuration of the components, wherein a magnet is adjacent to a coil, and either the magnet or the coil is fixed to the shell, the other being suspended by a spring suspension system, such as to allow movement of the magnet relative to the coil within the shell 101.

Not shown in FIG. 1A, an assembly of the second shell 102 may substantially mimic the assembly of the first shell 101, such that when the first shell and second shell are assembled, the device 100 houses a total of four coils (e.g., 109) and two encasements (e.g., 106) of permanent magnets supported by four springs (e.g., 107). When the first shell 101 and second shell 102 are assembled together, a first encasement of the first shell 101 and a second encasement of the second shell 102 may be placed adjacent to each other. In some instances, a coil of the first shell 101 and a spring of the second shell 102 may be placed adjacent to each other and a spring of the first shell 101 and a coil of the second shell 102 may be placed adjacent to each other.

In some instances, the device 100 may be without a shell (e.g., first shell 101, second shell 102). For example, the components housed in the cavity defined by the shell may be installed into or onto an external device. Such external device may be any device that experiences frequent or infrequent impacts and vibrations. For example, such external device may be a basketball backboard, wherein the springs and magnets are separately attached to the backboard (as opposed to attaching a shelled device to the backboard).

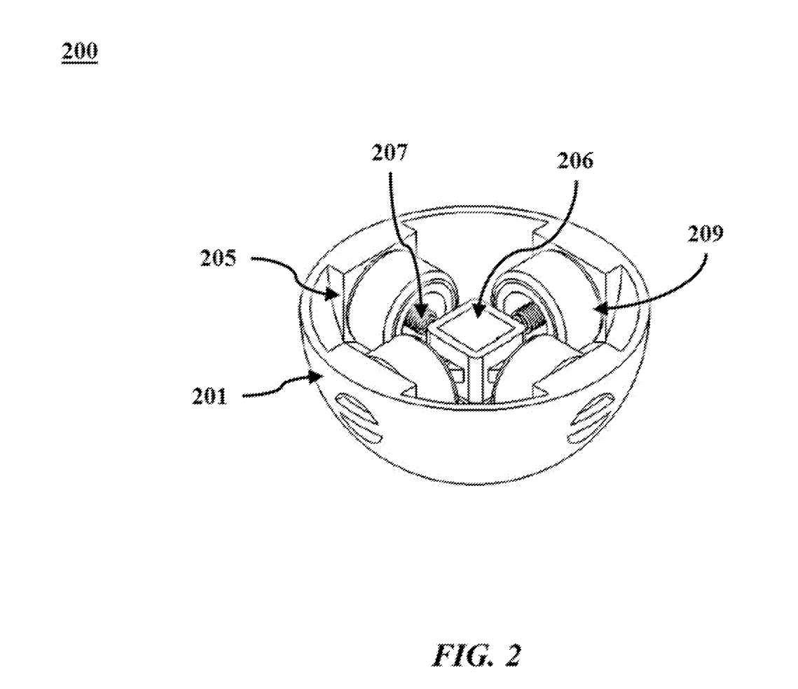

FIG. 2 shows a perspective view of a partial assembly of another embodiment of an energy harvesting system. An energy harvesting system 200 comprises a shell 201 which defines a cavity. The shell 201 can be substantially hemispherical. The shell 201 can be another arbitrary shape. In the cavity, a first permanent magnet encasement 206 may be suspended via a first spring suspension system 207 in a first linear direction. The first permanent magnet encasement 206 may be suspended adjacent to one or more sets of conductive coils 209 wrapped around a shaft 205. A spring in the spring suspension system 207 may be disposed within a tube defined by a coil in the conductive coils 209. That is, a longitudinal axis of a coil and a longitudinal axis of a spring may be substantially parallel and/or coincident. For example, a spring and a coil may be concentric. Alternatively, a spring and a coil may not be concentric. As shown in FIG. 2, where the first encasement 206 defines a substantially cuboid shape, and has six faces including a top face, bottom face, and four side faces. The four side faces of the first encasement 206 may each be adjacent to both a spring (e.g., 207) and a coil (e.g., 209), the spring disposed within a tube defined by the coil.

In some instances, a second permanent magnet may be suspended via a second spring suspension system in a second linear direction. The second permanent magnet may be suspended adjacent to one or more sets of conductive coils. Not shown in FIG. 2, an assembly of a second shell may substantially mimic the assembly of the shell 201, such that when the shell 201 and the second shell are assembled, the device 200 houses a total of eight coils (e.g., 209) and two encasements (e.g., 206) of permanent magnets supported by eight springs (e.g., 207).

The same motion (e.g., impact, acceleration, rotation, etc.) of the shell 201 may cause different oscillations (in strength and/or direction) in each of the two suspended permanent magnets. The respective oscillation of different permanent magnets may produce a magnetic flux over the same set of conductive coils, such as with different flux strengths. In some instances, the first permanent magnet and the second permanent magnet may be adjacent to each other. For example, the first and second permanent magnets can be stacked on top of each other. The first permanent magnet and the second permanent magnet may or may not contact each other. In some instances, a third permanent magnet, fourth permanent magnet, fifth permanent magnet, and more permanent magnets can be suspended in the same or different directions. Beneficially, kinetic energy coming from multi-directional motions may be efficiently harvested by the plurality of multi-directional suspended permanent magnets. The electrical energy generated by each of the magnets may be electrically coupled to an electrical system, such as printed circuit board, battery, socket, other electrical loads, electrical circuits, electrical components, and/or electrical storage system (e.g., capacitor, supercapacitor, cells, etc.). Electrical loads can include electrical application units, such as lamps, mobile phones, computers, wearable devices, electrical accessories, and other electrical appliances.

While the energy harvesting systems and methods have been described herein primarily with reference to a recreational device, such as a device, the energy harvesting systems and methods are not limited as such. For example, the device can be a utility device, such as a backpack, a floor panel, seat cushion, a hammer, and/or other tool. The device can also be any other type of mobile or personal device, such as a wearable device (e.g., fitness tracker), mobile phone case, fashion accessory, etc. The kinetic energy can be exerted on the device by a biological subject and/or machine. The device can be any object that experiences sudden or abrupt movements, impacts, and/or rotations. The device can be portable or non-portable. For example, the device can be integrated into a fixed infrastructure (e.g., floor panel, seat cushion, chair base, stairways, suspension systems, etc.).

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. An energy harvesting device, comprising:
a shell defining a cavity;
a first magnet disposed in said cavity, wherein said first magnet is suspended by a first set of springs that is fixed relative to said shell, and wherein said first magnet is configured to oscillate in a first linear direction;
a second magnet disposed in said cavity, wherein said second magnet is suspended by a second set of springs that is fixed relative to said shell, and wherein said second magnet is configured to oscillate in a second linear direction different from said first linear direction; and
a set of conductive coils wrapped around a shaft disposed in said cavity, wherein said shaft is fixed relative to said shell, and wherein said set of conductive coils is adjacent to at least one of said first magnet and said second magnet.

2. The device of claim 1, wherein said set of conductive coils is adjacent to both said first magnet and said second magnet.

3. The device of claim 2, wherein longitudinal axes of coils in said set of conductive coils are present in at most two planes.

4. The device of claim 2, wherein said first magnet and said second magnet are adjacent and not in contact.

5. The device of claim 1, wherein said shell is substantially spherical.

6. The device of claim 1, further comprising a storage device in electrical connection with said set of conductive coils, wherein said storage device is disposed within said cavity.

7. The device of claim 1, wherein said first magnet or said second magnet is a permanent magnet.

8. The device of claim 1, wherein said set of conductive coils is adjacent to said first magnet, and wherein a first longitudinal axis of a given spring in said first set of springs is substantially perpendicular to a second longitudinal axis of a given coil in said set of conductive coils.

9. The device of claim 1, wherein said set of conductive coils is adjacent to said first magnet, and wherein a first longitudinal axis of a given spring in said first set of springs is substantially parallel to a second longitudinal axis of a given coil of said set of conductive coils.

10. The device of claim 9, wherein said given spring is disposed within a tube defined by said given coil.

11. A method for harvesting energy, comprising:
(a) providing a device comprising: a shell defining a cavity; a first magnet disposed in said cavity, wherein said first magnet is suspended by a first set of springs that is fixed relative to said shell, and wherein said first magnet is configured to oscillate in a first linear direction; a second magnet disposed in said cavity, wherein said second magnet is suspended by a second set of springs that is fixed relative to said shell, and wherein said second magnet is configured to oscillate in a second linear direction different from said first linear direction; and a set of conductive coils wrapped around a shaft disposed in said cavity, wherein said shaft is fixed relative to said shell, and wherein said conductive coils is adjacent to at last one of said first magnet and said second magnet; and
(b) subjecting said device to a brief movement, impact, vibration, or rotation.

12. The method of claim 11, wherein said set of conductive coils is adjacent to both said first magnet and said second magnet.

13. The method of claim 12, wherein longitudinal axes of coils in said set of conductive coils are present in at most two planes.

14. The method of claim 12, wherein said first magnet and said second magnet are adjacent and not in contact.

15. The method of claim 11, wherein said shell is substantially spherical.

16. The method of claim 11, further comprising storing electrical energy harvested by said set of conductive coils to a storage device in electrical connection with said set of conductive coils.

17. The method of claim 11, wherein said first magnet or said second magnet is a permanent magnet.

18. The method of claim 11, wherein said set of conductive coils is adjacent to said first magnet, and wherein a first longitudinal axis of a given spring in said first set of springs is substantially perpendicular to a second longitudinal axis of a given coil in said set of conductive coils.

19. The method of claim 11, wherein said set of conductive coils is adjacent to said first magnet, and wherein a first longitudinal axis of a given spring in said first set of springs is substantially parallel to a second longitudinal axis of a given coil of said set of conductive coils.

20. The method of claim 19, wherein said given spring is disposed within a tube defined by said given coil.
